(19) United States
(12) Patent Application Publication
(10) Pub. No.: US 2025/0054371 A1
(43) Pub. Date: Feb. 13, 2025

(54) GAME OPERATION HAVING PREDEFINED DISPLAY PATTERNS FOR TRIGGERING A BONUS GAME IN A RANDOM BASED GAMING ARCHITECTURE

(71) Applicant: Aristocrat Technologies, Inc., Las Vegas, NV (US)

(72) Inventors: Daniel Marks, Decatur, GA (US); Hua Xu, Marietta, GA (US)

(21) Appl. No.: 18/239,513

(22) Filed: Aug. 29, 2023

Related U.S. Application Data
(60) Provisional application No. 63/531,215, filed on Aug. 7, 2023.

(51) Int. Cl. G07F 17/32

(52) U.S. Cl. CPC G07F 17/3267; G07F 17/3213

(57) ABSTRACT

An electronic gaming device is configured to display a matrix of symbol positions formed by a plurality of independent reels. The matrix of symbol positions define a play area, and the reels have different distributions of credit symbols. The device is further configured to identify first predefined pattern(s) defined in the play area, determine a first outcome that includes a first plurality of symbols to display in the play area, determine whether a first subset of symbols of the first plurality of symbols correspond to the first predefined pattern(s), and in response to determining that the first subset of symbols correspond, hold at least the first subset of symbols in place within the play area. The device is further configured to determine a second outcome that includes a second plurality of symbols to display in the play area within the matrix that do not correspond to the first predefined pattern(s).

### CROSS-REFERENCE TO RELATED APPLICATIONS

This application claims priority to U.S. Provisional Patent Application No. 63/531,215 filed Aug. 7, 2023, and titled “ELECTRONIC GAME SYSTEMS AND METHODS HAVING PREDEFINED DISPLAY PATTERNS FOR TRIGGERING A BONUS GAME”, which is hereby incorporated by reference in its entirety.

### TECHNICAL FIELD

The field of disclosure relates generally to random-based games having bonus or feature games, and more particularly, to gaming operations that include displaying symbols in symbol positions that form predefined patterns that trigger feature or bonus games, wherein the random-based games are executed in an online or in a casino environment.

### BACKGROUND

Electronic gaming machines (EGMs), or gaming devices or other electronic game devices, provide a variety of wagering or non-wagering games such as, for example, and without limitation, slot games, video poker games, video blackjack games, roulette games, video bingo games, keno games, and other types of games that are frequently offered at casinos and other locations. Play on EGMs typically involves a player establishing a credit balance by inserting or otherwise submitting money and placing a monetary wager (deducted from the credit balance) on one or more outcomes of an instance, or play, of a primary game, sometimes referred to as a base game. In many games, a player may qualify for secondary games or bonus rounds by attaining a certain winning combination or other triggering event in the base game. Secondary games provide an opportunity to win additional game instances, credits, awards, jackpots, progressives, etc. Awards from any winning outcomes are typically added back to the credit balance and can be provided to the player upon completion of a gaming session or when the player wants to “cash out.”

Slot games are often displayed to the player in the form of various symbols arranged in a row-by-column grid, or “matrix,” which may define a plurality of symbol positions, and which may be generated by spinning a plurality of reels, each of which may correspond to a respective column of the matrix. Specific matching combinations of symbols along predetermined paths, or paylines, drawn through the matrix indicate the outcome of the game. The display typically highlights winning combinations and outcomes for ready identification by the player. Matching combinations and their corresponding awards are usually shown in a “pay-table” that is available to the player for reference. Often, the player may vary his/her wager to include differing numbers of paylines and/or the amount bet on each line. By varying the wager, the player may sometimes alter the frequency or number of winning combinations, the frequency or number of secondary games, and/or the amount awarded.

Typical games use a random number generator (RNG) to randomly determine the outcome of each game. The game is designed to return a certain percentage of the amount wagered back to the player, referred to as return to player (RTP), over the course of many plays or instances of the game. The RTP and randomness of the RNG are fundamental to ensuring the fairness of the games and are therefore highly regulated. The RNG may be used to randomly determine the outcome of a game and symbols may then be selected that correspond to that outcome. Alternatively, the RNG may be used to randomly select the symbols whose resulting combinations determine the outcome. Notably, some games may include an element of skill on the part of the player and are therefore not entirely random.

### SUMMARY

In one aspect, an electronic gaming device is provided. The electronic gaming device includes a display device, at least one memory device, and at least one processor configured to execute programmed instructions stored in the at least one memory device. The programmed instructions, when executed, cause the at least one processor to control the display device to display a matrix of symbol positions formed by a plurality of independent reels, where the matrix of symbol positions define a play area and where the plurality of independent reels have different distributions of credit symbols. The programmed instructions, when executed, further cause the at least one processor to identify one or more first predefined patterns defined in the play area, and in response to receipt of an input to play an instance of a game, determine a first outcome, based at least in part on an output of a RNG, that includes a first plurality of symbols to display in the play area. The programmed instructions, when executed, further cause the at least one processor to determine whether a first subset of symbols of the first plurality of symbols displayed in the play area correspond to the one or more first predefined patterns defined within the play area, and in response to determining that the first subset of symbols correspond to the one or more first predefined patterns defined in the play area, control the display device to hold at least the first subset of symbols in place within the play area. The programmed instructions, when executed, further cause the at least one processor to determine a second outcome, based at least in part on an output of the RNG, that includes a second plurality of symbols to display in the play area within the matrix of symbol positions that do not correspond to the one or more first predefined patterns.

In another aspect, a method operable by an electronic gaming device that includes a display device is provided. The method includes controlling the display device to display a matrix of symbol positions formed by a plurality of independent reels, where the matrix of symbol positions define a play area, and where the plurality of independent reels have different distributions of credit symbols. The method further includes identifying one or more first predefined patterns defined in the play area, and in response to receipt of an input to play an instance of a game, determining a first outcome, based at least in part on an output of a RNG, that includes a first plurality of symbols to display in the play area. The method further includes determining whether a first subset of symbols of the first plurality of symbols displayed in the play area correspond to the one or more first predefined patterns defined within the play area, and in response to determining that the first subset of symbols correspond to the one or more first predefined patterns defined in the play area, controlling the display device to hold at least the first subset of symbols in place within the play area. The method further includes determining a second outcome, based at least in part on an output of the RNG, that includes a second plurality of symbols to display in the play area within the matrix of symbol positions that do not correspond to the one or more first predefined patterns.

In another aspect, a non-transitory computer-readable medium embodying programmed instructions is provided. The programmed instructions, when executed by at least one processor of a gaming device that includes a display device, cause the at least one processor to control the display device to display a matrix of symbol positions formed by a plurality of independent reels, where the matrix of symbol positions define a play area, and where the plurality of independent reels have different distributions of credit symbols. The programmed instructions, when executed, further cause the at least one processor to identify one or more first predefined patterns defined in the play area, and in response to receipt of an input to play an instance of a game, determine a first outcome, based at least in part on an output of a RNG, that includes a first plurality of symbols to display in the play area. The programmed instructions, when executed, further cause the at least one processor to determine whether a first subset of symbols of the first plurality of symbols displayed in the play area correspond to the one or more first predefined patterns defined within the play area, and in response to determining that the first subset of symbols correspond to the one or more first predefined patterns defined in the play area, control the display device to hold at least the first subset of symbols in place within the play area. The programmed instructions, when executed, further cause the at least one processor to determine a second outcome, based at least in part on an output of the RNG, that includes a second plurality of symbols to display in the play area within the matrix of symbol positions that do not correspond to the one or more first predefined patterns.

### BRIEF DESCRIPTION OF THE DRAWINGS

An example embodiment of the subject matter disclosed will now be described with reference to the accompanying drawings.

FIG. 1 is an example diagram showing several EGMs networked with various gaming-related servers.

FIG. 2A is a block diagram showing various functional elements of an example EGM.

FIG. 2B depicts a casino gaming environment according to one example embodiment.

FIG. 2C is a diagram that shows examples of components of a system for providing online gaming according to some aspects of the present disclosure.

FIG. 3 illustrates, in block diagram form, an implementation of a game processing architecture algorithm that implements a game processing pipeline for the play of a game in accordance with various implementations described herein.

FIG. 4 depicts an example gaming user interface for a gaming device.

FIGS. 5-7 depict examples of the gaming user interface during a hold and spin feature game.

FIGS. 8-11 depict examples of the gaming user interface during a second chance feature game.

FIGS. 12-16 depict examples of the gaming user interface during the activation of a metamorphic feature.

FIG. 17 depicts a flowchart illustrating and summarizing a gaming operation that implements the gaming user interface.

### DETAILED DESCRIPTION

In the example embodiments described herein, an electronic game play system having a game play computing device is described. The game play device may be an EGM or an online mobile device in communication with a game server. The game play device includes a display device, at least one memory device, and at least one processor configured to execute programmed instructions stored in the memory device. The at least one processor is programmed to: control the display device to display a matrix of symbol positions formed by a plurality of reels, each reel of the plurality of reels including a plurality of symbol positions, the matrix of symbol positions defining a play area; identify one or more first predefined patterns defined within the play area; in response to receipt of an input to play an instance of a game, determine a first outcome, based at least in part on an output of a RNG, that includes a first plurality of symbols to display in the play area; determine whether a first subset of symbols of the first plurality of symbols displayed in the play area correspond to the one or more first predefined patterns defined within the play area; in response to determining that the first subset of symbols correspond to the one or more first predefined patterns defined within the play area, control the display device to hold at least the first subset of symbols in place within the play area; and determine a second outcome, based at least in part on an output of the RNG, that includes a second plurality of symbols to display in the play area within the matrix of symbol positions that do not correspond to the one or more first predefined patterns.

In some embodiments, the at least one processor is further programmed to: determine whether a second subset of symbols of the second plurality of symbols displayed in the play area correspond to one or more second predefined patterns defined within the play area, in response to determining that the second subset of symbols correspond to the one or more second predefined patterns defined within the play area, control the display device to hold at least the second subset of symbols in place within the play area, and determine a third outcome, based at least in part on an output of the RNG, that includes a third plurality of symbols to display in the play area within the matrix of symbol positions that do not correspond to the one or more second predefined patterns. In some embodiments, the one or more first predefined patterns and the one or more second predefined patterns comprise a same pattern. In other embodiments, the one or more first predefined patterns comprise bingo patterns. In some embodiments, the first subset of symbols comprises credit symbols.

In some embodiments, the at least one processor is further programmed to, in response to determining that the first subset of symbols correspond to the one or more first predefined patterns defined within the play area, control the display device to hold at least one symbol of the first plurality of symbols in place that do not correspond with the one or more first predefined patterns. In some embodiments, the at least one symbol comprises a credit symbol.

In some embodiments, the at least one processor is further programmed to: evaluate the play area against a plurality of predefined winning bingo patterns to determine that a predefined winning bingo pattern is formed in the play area, and in response to determining that the predefined winning bingo pattern is formed, determine an award value based at least in part on values of prize symbols forming the predefined winning bingo pattern in the play area. In some embodiments, the predefined winning bingo pattern comprises the one or more first predefined patterns.

In prior games that utilize a bingo card and a slot game, to trigger a payout, the slot game could form a bingo line on the bingo card after multiple spins. Specifically, the credit symbols in the slot matrix would be transferred to the bingo card. The credit symbols transferred to the bingo card would persist over multiple spins eventually allowing the player to obtain a bingo win. The credit symbol values can grow as more and more credit symbols land in the same symbol matrix position. However, if the game removes the persistent aspects of the bingo game (e.g., credit symbols do not stay over multiple spins), the slot game may be unable to utilize a bingo win mechanic without further improvement. Specifically, rather than achieving a bingo win pattern over multiple spins, the slot game would need to be designed such that a bingo win pattern could randomly be achieved with a fewer number of spins (e.g., a single spin).

The present embodiments described herein include a single spin bingo that removes the persistent aspect. To do so, the bingo card and the slot game are integrated together into a single matrix. The additional bingo card is no longer needed since the persistence aspects of the prior bingo game is now gone. The slot matrix utilizes an independent reel at each of the symbol positions (e.g., 25 different reels) instead of a single reel for each column (e.g., 5 independent reels) as done in the prior games. By utilizing independent reels and varying the number of credit symbols for each the independent reels, the game now provides a greater degree of control of when a bingo win line appears within a fewer number of spins (e.g., a single spin). Having a greater degree of control in a random gaming environment also helps with obtaining/achieving a certain return to player (RTP) while using the bingo game mechanic.

In one or more embodiments, rather than paying out a bingo game win after landing a bingo win line, the game triggers a hold and spin feature that potentially allows for more bingo wins. In addition, the credit symbol values could grow given the persistent nature. Adding such a feature provides a gaming operation to increase the RTP bingo game to a desired target level by providing the opportunity to increase the payout. For example, a hold and spin feature can add more credit symbols to generate additional bingo win lines to increase the payout.

In the present disclosure, at least one of the technical improvements is that the various embodiments described herein, by integrating the game play matrix with the predefined patterns (e.g., bingo patterns), have created a gaming operation that allows a player to win or trigger a bonus game on a single spin. Known systems do not integrate these predefined patterns and the metamorphic feature into the game play matrix. Rather, the known systems include a separate matrix and bingo card that gets populated as spins occur. These known systems typically require the player to make multiple spins to fill up the bingo card and the player to keep playing over time, and thus, the player would need to track two separate gaming matrixes over multiple spins. Having to present multiple matrixes may be especially problematic when the gaming devices are mobile devices with limited display space. By integrating the predefined patterns into a single game play matrix, the implementations disclosed herein allow a player to monitor a single area while triggering an award and/or a bonus game on potentially a fewer number of spins (e.g., a single spin). The implementations described herein may reduce the amount of display space to show the game filing up a predefined pattern or hit a metamorphic (described later) to trigger the bonus or feature game. Such gaming operations may also include other technical improvements, such as reduced memory usage, improved user interface (as fewer items need to be displayed to the player because of the integration), improved computational speeds because fewer items are displayed and less data is stored, thereby allowing the various embodiments described herein to be implemented on smaller and/or computationally limited devices, such as smart phones, tablets, etc., while still providing the functionality to award winning spins, bonus games, and hold and spin features, etc. Further, because game play is based in part on predefined patterns which trigger additional features, the game play is more varied by modifying the predefined patterns during game play, which improves the player's experience and reduces repetition in the style of game play that is presented to the user.

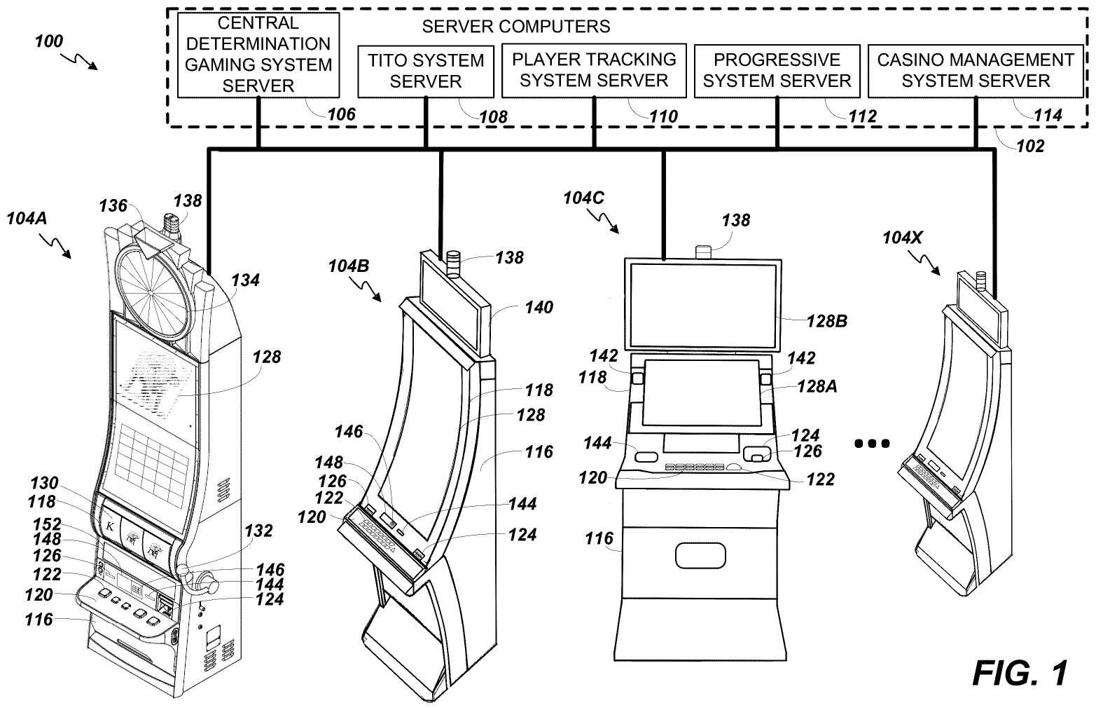

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console, although such devices may require specialized software and/or hardware to comply with regulatory requirements regarding devices used for wagering or games of chance in which monetary awards are provided.

Communication between the gaming devices 104A-104X and the server computers 102, and among the gaming devices 104A-104X, may be direct or indirect, such as over the Internet through a website maintained by a computer on a remote server or over an online data network including commercial online service providers, Internet service providers, private networks, and the like. In other embodiments, the gaming devices 104A-104X may communicate with one another and/or the server computers 102 over RF, cable TV, satellite links and the like.

In some embodiments, server computers 102 may not be necessary and/or preferred. For example, in one or more embodiments, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main or service door which provides access to the interior of the cabinet. Gaming device 104A typically includes a button area or button deck 120 accessible by a player that is configured with input switches or buttons 122, an access channel for a bill validator 124, and/or an access channel for a ticket-out printer 126.

In FIG. 1, gaming device 104A is shown as a Relm XL™ model gaming device manufactured by Aristocrat® Technologies, Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution LCD, plasma, LED, or OLED panel which may be flat or curved as shown, a cathode ray tube, or other conventional electronically controlled video monitor.

In some embodiments, the bill validator 124 may also function as a “ticket-in” reader that allows the player to use a casino issued credit ticket to load credits onto the gaming device 104A (e.g., in a cashless ticket (“TITO”) system). In such cashless embodiments, the gaming device 104A may also include a “ticket-out” printer 126 for outputting a credit ticket when a “cash out” button is pressed. Cashless TITO systems are well known in the art and are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition, there can be additional meters that record the total amount of money wagered on the gaming machine, total amount of money deposited, total amount of money withdrawn, total amount of winnings on gaming device 104A.

In some embodiments, a player tracking card reader 144, a transceiver for wireless communication with a player's smartphone, a keypad 146, and/or an illuminated display 148 for reading, receiving, entering, and/or displaying player tracking information is provided in gaming device 104A. In such embodiments, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example, a game denomination (e.g., $0.25 or $1), pay lines, pay tables, and/or various game related graphics. In some embodiments, the information panel(s) 152 may be implemented as an additional video display.

Gaming devices 104A have traditionally also included a handle 132 typically mounted to the side of main cabinet 116 which may be used to initiate game play.

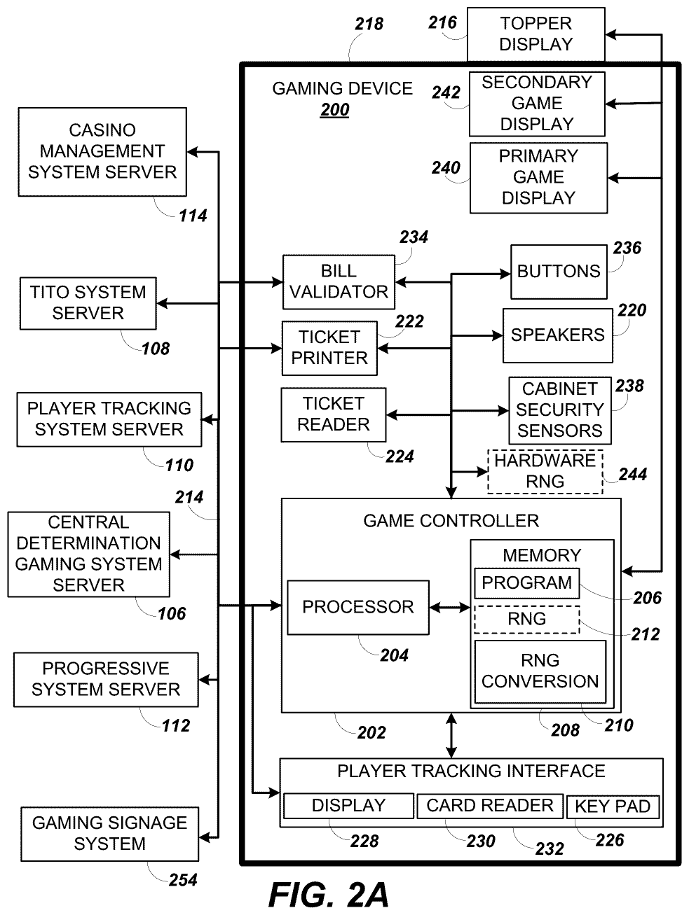

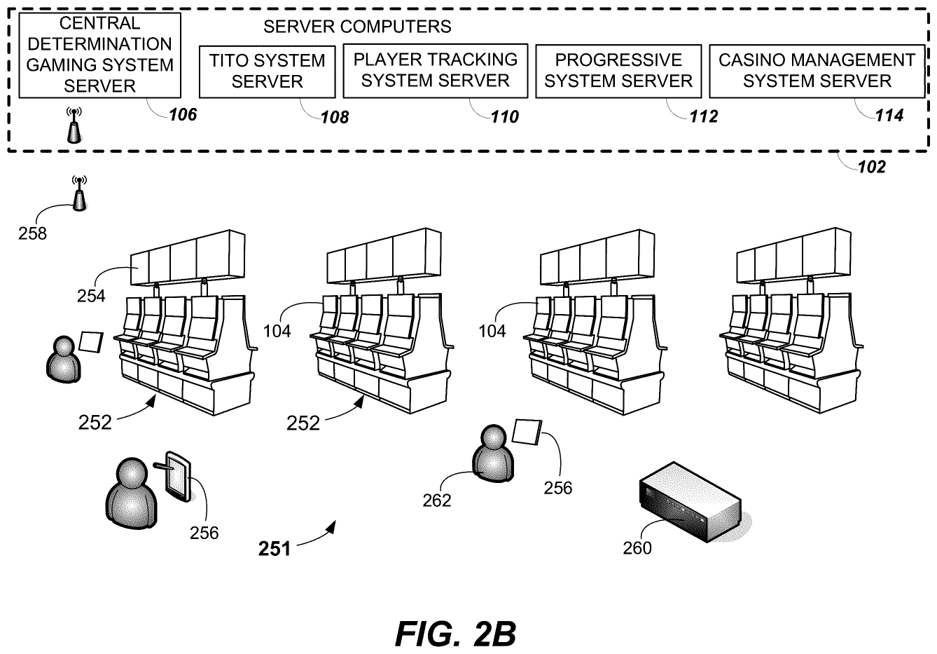

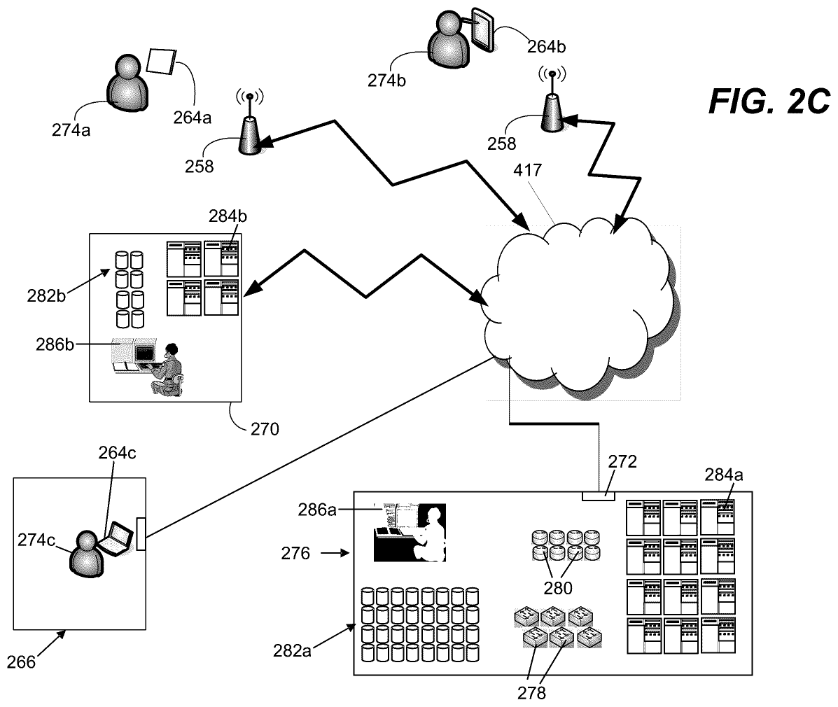

Many or all the above described components can be controlled by circuitry (e.g., a gaming controller) housed inside the main cabinet 116 of the gaming device 104A, the details of which are shown in FIG. 2A.

Note that not all gaming devices suitable for implementing embodiments of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards.

An alternative example gaming device 104B illustrated in FIG. 1 is the Arc™ model gaming device manufactured by Aristocrat® Technologies, Inc. Note that where possible, reference numerals identifying similar features of the gaming device 104A embodiment are also identified in the gaming device 104B embodiment using the same reference numbers. Gaming device 104B does not include physical reels and instead shows game play functions on main display 128. A topper screen 140 (which may be optional) may be used as a secondary game display for bonus play, to show game features or attraction activities while a game is not in play, or any other information or media desired by the game designer or operator. In some embodiments, topper screen 140 may also or alternatively be used to display progressive jackpot prizes available to a player during play of gaming device 104B.

Example gaming device 104B includes a main cabinet 116 including a main or service door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix™ model gaming device manufactured by Aristocrat® Technologies, Inc. Example gaming device 104C includes a main display 128A that is in a landscape orientation. Although not illustrated by the front view provided, the main display 128A may have a curvature radius from top to bottom, or alternatively from side to side. In some embodiments, main display 128A is a flat panel display. Main display 128A is typically used for primary game play while secondary display 128B is typically used for bonus game play, to show game features or attraction activities while the game is not in play, or any other information or media desired by the game designer or operator. In some embodiments, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the example gaming device 200 shown could be used to implement any one of the example gaming devices 104A-X depicted in FIG. 1. The games available for play on the gaming device 200 are controlled by a game controller 202 that includes one or more processors 204 and a game that may be stored as game software or a program 206 in a memory 208 coupled to the processor 204. The memory 208 may include one or more mass storage devices or media that are housed within gaming device 200. Within the mass storage devices and/or memory 208, one or more databases may be provided for use by the program 206. A random number generator (RNG) 212 that can be implemented in hardware and/or software is typically used to generate random numbers that are used in the operation of game play to ensure that game play outcomes are random and meet regulations for a game of chance.

Alternatively, a game instance (i.e., a play or round of the game) may be generated on a remote gaming device such as a central determination gaming system server 106 (not shown in FIG. 2A but see FIG. 1). The game instance is communicated to gaming device 200 via the network 214 and then displayed on gaming device 200. Gaming device 200 may execute game software, such as but not limited to video streaming software that allows the game to be displayed on gaming device 200. When a game is stored on gaming device 200, it may be loaded from a memory 208 (e.g., from a read only memory (ROM)) or from the central determination gaming system server 106 to memory 208. The memory 208 may include RAM, ROM or another form of storage media that stores instructions for execution by the processor 204. Note that embodiments of the present disclosure represent an improvement in the art of EGM software/progressives and provide new technology in that they facilitate a cross-game or multi-game determination whether a player may be eligible to participate in a progressive award determination and/or whether to award a progressive jackpot. These embodiments are thus not merely new game rules or simply a new display pattern.

The gaming device 200 may include a topper display 216 or another form of a top box (e.g., a topper wheel, a topper screen, etc.) which sits above cabinet 218. The cabinet 218 or topper display 216 may also house a number of other components which may be used to add features to a game being played on gaming device 200, including speakers 220, a ticket printer 222 which prints bar-coded tickets or other media or mechanisms for storing or indicating a player's credit value, a ticket reader 224 which reads bar-coded tickets or other media or mechanisms for storing or indicating a player's credit value, and a player tracking interface 232. The player tracking interface 232 may include a keypad 226 for entering information, a player tracking interface display 228 for displaying information (e.g., an illuminated or video display), a card reader 230 for receiving data and/or communicating information to and from media or a device such as a smart phone enabling player tracking. Ticket printer 222 may be used to print tickets for a TITO system server 108. The gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

Gaming device 200 may be connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

Gaming devices, such as gaming devices 104A-104X, 200, are highly regulated to ensure fairness and, in many cases, gaming devices 104A-104X, 200 are operable to award monetary awards (e.g., typically dispensed in the form of a redeemable voucher). Therefore, to satisfy security and regulatory requirements in a gaming environment, hardware and software architectures are implemented in gaming devices 104A-104X, 200 that differ significantly from those of general-purpose computers. Adapting general purpose computers to function as gaming devices 200 is not simple or straightforward because of: 1) the regulatory requirements for gaming devices 200, 2) the harsh environment in which gaming devices 200 operate, 3) security requirements, 4) fault tolerance requirements, and 5) the requirement for additional special purpose componentry enabling functionality of an EGM. These differences require substantial engineering effort with respect to game design implementation, hardware components and software.

When a player wishes to play the gaming device 200, he/she can insert cash or a ticket voucher through a coin acceptor (not shown) or bill validator 234 to establish a credit balance on the gamine machine. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152 (FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card, via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations, the casino 251 may include one or more kiosks 260 that are configured to facilitate monetary transactions involving the mobile gaming devices 256, which may include cash out and/or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding amount of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256, which may include a real button or a virtual button (e.g., a button provided via a graphical user interface) in some instances. In some such examples, the mobile gaming device 256 may send a “cash out” signal to a kiosk 260 via a wireless link in response to receiving a “cash out” indication from a casino patron. The kiosk 260 may provide monetary credits to the casino patron 262 corresponding to the “cash out” signal, which may be in the form of cash, a credit ticket, a credit transmitted to a financial account corresponding to the casino patron, etc.

In some implementations, a cash-in process and/or a cash-out process may be facilitated by the TITO system server 108. For example, the TITO system server 108 may control, or at least authorize, ticket-in and ticket-out transactions that involve a mobile gaming device 256 and/or a kiosk 260.

Some mobile gaming devices 256 may be configured for receiving and/or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron's player loyalty card, a patron's smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a, 264b and 264c are capable of communication via one or more networks 290. The networks 290 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming, although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 290. The gaming data center 276 is capable of communication with the networks 290 via the gateway 272. In this example, switches 278 and routers 280 are configured to provide network connectivity for devices of the gaming data center 276, including storage devices 282a, servers 284a and one or more workstations 286b. The servers 284a may, for example, be configured to provide access to a library of games for online game play. In some examples, code for executing at least some of the games may initially be stored on one or more of the storage devices 282a. The code may be subsequently loaded onto a server 284a after selection by a player via an EUD and communication of that selection from the EUD via the networks 290. The server 284a onto which code for the selected game has been loaded may provide the game according to selections made by a player and indicated via the player's EUD. In other examples, code for executing at least some of the games may initially be stored on one or more of the servers 284a. Although only one gaming data center 276 is shown in FIG. 2C, some implementations may include multiple gaming data centers 276.

In this example, a financial institution data center 270 is also configured for communication via the networks 290. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a-274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player's “cash in” selections, wagering game results and a player's “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and/or storage devices. In some alternative examples, the financial institution data center 270 and/or the gaming data center 276 may rely entirely on cloud-based servers.

One or more types of devices in the gaming data center 276 (or elsewhere) may be capable of executing middleware, e.g., for data management and/or device communication. Authentication information, player tracking information, etc., including but not limited to information obtained by EUDs 264 and/or other information regarding authorized users of EUDs 264 (including but not limited to the authorized users 274a-274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices (such EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

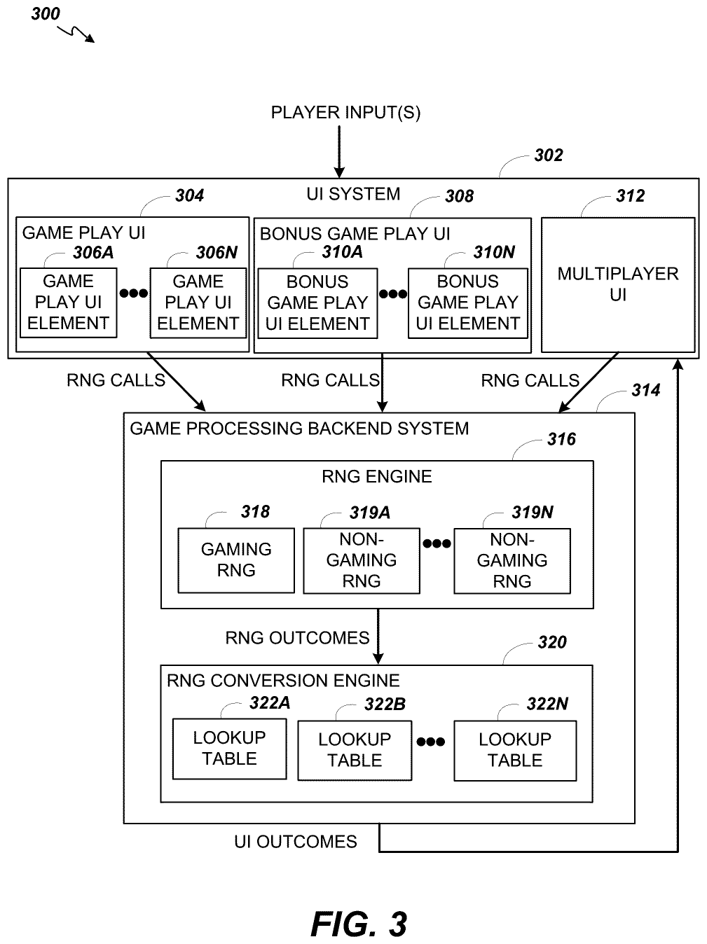

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device, such as gaming devices 104A-104X and 200 shown in FIGS. 1 and 2, respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact with. The UI system 302 could include one or more game play UIs 304, one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and/or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player's gaming experience, tournament mode can modify and synchronize sound, music, reel spin speed, and/or other operations of the gaming devices according to the tournament game play. After tournament game play ends, operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A). Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A, RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

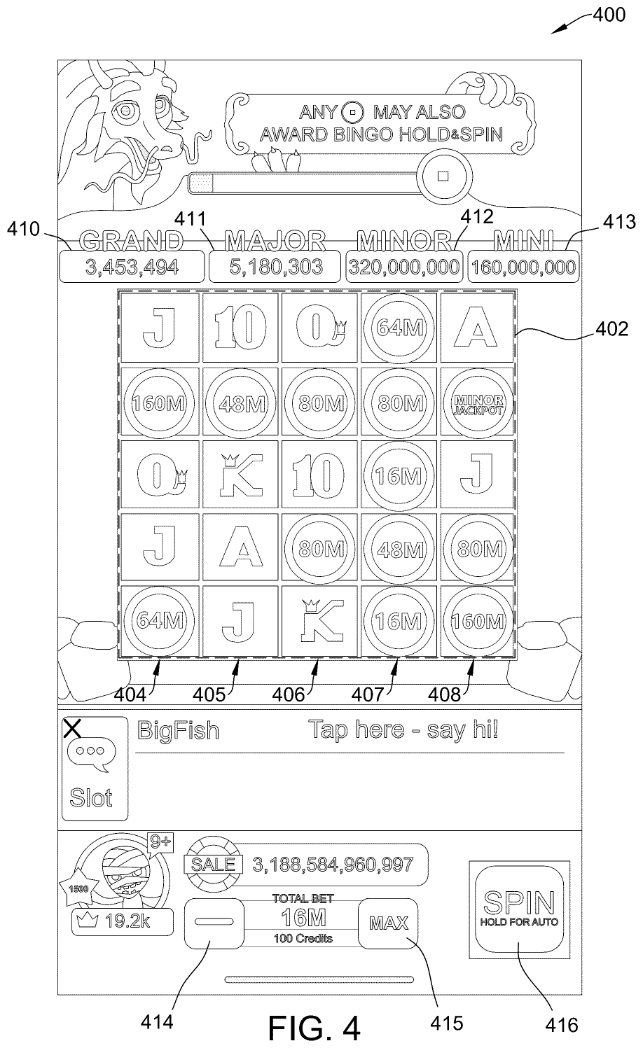

FIG. 4 depicts an example gaming user interface 400 shown on a gaming device, in which a play area 402 having a plurality of columns 404, 405, 406, 407, and 408 is displayed. In the example embodiment, as shown in FIG. 4, play area 402 includes a first column 404, a second column 405, a third column 406, a fourth column 407, and a fifth column 408. Each column 404, 405, 406, 407, and 408 can represent a separate reel or could have multiple reels (e.g., 5 reels) within each of columns 404, 405, 406, 407, and 408. Play area 402 could also have any suitable number of columns 404, 405, 406, 407, and 408, such as one column to columns numbering greater than five columns, may be implemented on a variety of embodiments.

In various embodiments, gaming user interface 400 may be displayed by and played on one or more gaming devices 104A-104X (as shown in FIG. 1 and FIG. 2A) and/or by mobile gaming device 256 (as shown in FIG. 2B). In other embodiments, gaming user interface 400 may displayed by and played on any other suitable computing device, such as a personal computer, a tablet computing device, a mobile communications device (e.g., a smartphone), and the like. Thus, it will be appreciated that gaming user interface 400 may be provided in either of a so-called “thick client” or “thin client” version. Although not central to an understanding of the present disclosure, in a thick client embodiment, all or at least a portion of gaming user interface 400 may be stored on a memory 208 of an EGM 104A-104X. In contrast, in a thin client embodiment, all or at least a portion of gaming user interface 400 may be served from a backend server system, such as any of servers 106-114.

Columns 404, 405, 406, 407, and 408 may include simulated or “virtual” columns generated and displayed by one or more processors 204 (such as processors of game controller 202) on any game display, such as primary game display 240, secondary game display 242, topper display 216, player tracking interface display 228, mobile gaming device 256, and/or any other suitable display device. In other embodiments, columns 404, 405, 406, 407, and 408 may include one or more physical or mechanical reels having a display element, such as a liquid crystal display (LCD), capable of displaying one or more symbols during gameplay. In other embodiments, columns 404, 405, 406, 407, and 408 may include a plurality of mechanical reels and/or a plurality of mechanical reels overlaid by an LCD panel. In such an embodiment, the LCD panel may be used to display a symbol that corresponds to either or both of the bingo boards displayed.

Each reel within columns 404, 405, 406, 407, and 408 may include a plurality of symbol positions, which may, together, define a matrix of symbol positions. Each symbol position may be designated by a row number (e.g., “1,” “2,” “3,” “4,” “5,” etc.) and a column letter (e.g., “A,” “B,” “C,” “D,” “E,” etc.) For example, the upper-left-most symbol position, occurring on column 404, may be designated by the symbol position “1A”, where symbol position 1A has its own reel strip. In the example embodiment, the matrix of symbol positions is a 5×5 matrix formed from five symbol positions from each of five columns 404, 405, 406, 407, and 408, where each symbol position has its own reel strip. In other words, each symbol position would have its own independent and separate reel strip. In other embodiments, the matrix of symbol positions may be of other dimensions (e.g., 4×4, 3×3, 4×5, 5x×4, or such). In still other embodiments, the matrix of symbol positions may be non-rectangular (e.g., column heights of 3, 5, 5, 5, 3 on five columns).

Each symbol position of each column 404, 405, 406, 407, and 408 may also include a symbol. In the exemplary embodiment, some of the symbols of one or more columns 404, 405, 406, 407, and 408 are “prize” symbols (indicating a prize, such as a cash or credit prize), and some of the symbols of each column 404, 405, 406, 407, and 408 are non-prize or “standard” symbols. As used herein, a “standard” symbol may refer to any symbol that is not a prize symbol, where again, a “prize” symbol may include any symbol displaying a cash or credit prize value. As used herein, a “wild” symbol may refer to any symbol capable of substituting, e.g., on a line win Or ways to win, for another symbol, including some or all standard symbols and/or value symbols. In some embodiments, one or more “jackpot” symbols may appear and may be used to identify jackpot wins in certain situations described in further detail below.

During a round of gameplay, each reel of columns 404, 405, 406, 407, and 408 may be spun and stopped to display a subset of the symbols of each column 404, 405, 406, 407, and 408, for example, using RNG engine 316. For example, in at least some embodiments, five symbol positions of each column 404, 405, 406, 407, and 408 may be selected and stopped by processor 204 based upon the one or more outcomes of RNG 212 to display five symbols, one in each selected and stopped symbol position, for presentation to a player.

In at least some embodiments, one or more consecutive symbols are selected from each column 404, 405, 406, 407, and 408 for presentation. For example, if a symbol at symbol position “1A” is selected by processor 204 for presentation, the symbols at symbol positions “2A” and “3A” may also be selected and displayed.

In addition, in some embodiments, one or more symbol display positions of columns 404, 405, 406, 407, and 408 may be spun and stopped independently and/or one at a time (or in groups at a time). For example, if one symbol position is spun and stopped at a time, and there are twenty-five symbol positions across the game play matrix, then each symbol position would include a reel that could spin so that all twenty-five reels would spin each time the game is played.

Thus, a plurality of symbols from each of columns 404, 405, 406, 407, and 408 may be displayed for presentation to a player of wagering (or credit wagering) gaming user interface 400. As described above, these symbols may include standard symbols as well as prize symbols. In certain embodiments, the value of prize symbols may be predetermined and preassigned to the reel strips. Various wager amount combinations/denomination levels may use their own reel strips that have prizes of value symbols increase as wager amount and/or denomination level increases. In certain embodiments, certain positions on reel strips may be earmarked for prize value symbols. The value of the symbols may be randomly selected from weighted tables, and the weighted tables may vary the distribution of the symbols based on their position within the matrix in some embodiments. Further, each denomination and/or wager amount may have a corresponding weighted table of prize values to be used.

In this embodiment, play area 402 includes a plurality of bingo positions, which may, together, define a matrix of bingo positions. Each bingo position may be designated by a row number (e.g., “1,” “2,” “3,” “4,” “5,” etc.) and a column letter (e.g., “A,” “B,” “C,” “D,” “E,” etc.) For example, the upper-left-most bingo position, occurring at the intersection of row 1 and column A, may be designated by the bingo position “1A.”

As a result, in the example embodiment, play area 402 includes a number of bingo positions equal to a number of symbol positions defined by columns 404, 405, 406, 407, and 408. For example, if there are twenty-five symbol positions on columns 404, 405, 406, 407, and 408, play area 402 likewise also includes twenty-five bingo positions. A one-to-one relationship may, in addition, be defined between each symbol position of columns 404, 405, 406, 407, and 408 and each bingo position of play area 402. In one example, a one-to-one relationship may be defined between symbol position “1A” and bingo position “1A,” whereby, as described herein, symbol position “1A” corresponds to bingo position “1A.” The remaining bingo positions may similarly correspond to a respective symbol position of columns 404, 405, 406, 407, and 408.

In the example embodiment, a plurality of jackpots 410, 411, 412, 413 may be displayed across a top edge (or in any other location) of gaming user interface 400. For example, a first jackpot 410, a second jackpot 411, a third jackpot 412, and a fourth jackpot 413 may be provided and displayed. Jackpots 410, 411, 412, 413 may, in various embodiments, include progressive jackpots, which it will be appreciated, may be incremented each time a player places a wager by a predefined increment or amount, and which may, as a result, slowly increase towards one or more maximum values. Although four jackpots 410, 411, 412, 413 are shown, any other suitable number of jackpots may be included in gaming user interface 400. In some embodiments, the prize symbols that get displayed on the columns may include one or more of the jackpot indicators.

In this embodiment, gaming user interface 400 comprises a 5×5 reel power game, and all twenty-five positions within play area 402 may spin individually. While playing gaming user interface 400, a player wagers credits via wager buttons 414, 415 and spins reels in columns 404, 405, 406, 407, and 408 using spin button 416. In this embodiment, the symbol positions in columns 404, 405, 406, 407, and 408 include royal symbols, major symbols, wild symbols, and WYSIWYG value symbols, corresponding to credits, mini, minor, and major symbols. During game play, the player is attempting to win prizes through reel power wins paying left to right in play area 402 and bingo line wins within play area 402. However, in other embodiments, the gaming device generates win prizes when the symbols form one or more predefined patterns, such as bingo patterns. The predefined patterns may include, for example, symbols forming lines across the matrix (e.g., including horizontal, vertical, and/or diagonal lines), symbols at four corners of the matrix, or other types of predefined patterns. In some embodiments, the predefined patterns may be randomly assigned (e.g., at the beginning of the game or at other times), the predefined patterns may change over the course of game play, etc.

In this embodiment of gaming user interface 400, reels in columns 404, 405, 406, 407, and 408 spin independently. During a given round of play, the game operation spins all twenty-five positions independently. In other words, the gaming device assigns each symbol position independent reels to provide a greater degree of control. If a bingo line or one or more predefined patterns are achieved by the value symbols, a hold and spin feature game is triggered, which will be described in more detail below. The hold and spin feature may be triggered by a single spin (e.g., the player may achieve a bingo line or one or more predefined patterns on a single spin).

If the game operation spins and a bingo line or some other predefined patterns are not achieved, then all twenty-five positions may independently spin on the next spin. In any base game or bonus game, if the value symbols landed form one or more bingo lines or other predefined patterns, then the hold and spin feature game is triggered.

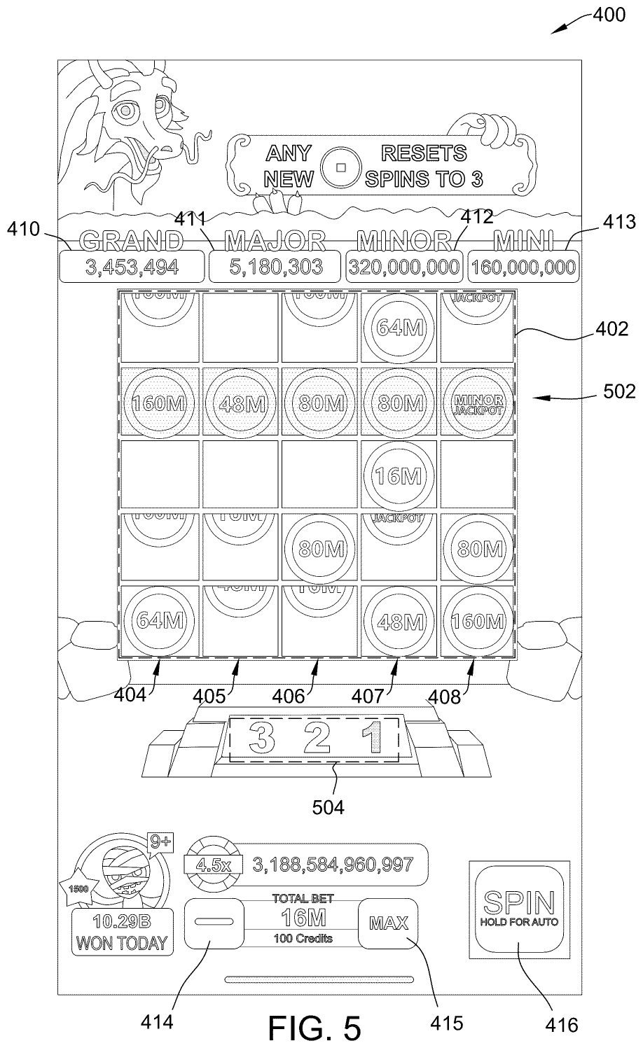

FIGS. 5-7 depicts examples of gaming user interface 400 during the hold and spin feature game. As discussed briefly above, the hold and spin feature game is triggered on any spin with value symbols forming one or more bingo lines or other predefined patterns, illustrated as bingo line 502 in FIG. 5. The hold and spin feature game may also be triggered based on other criteria, which will be described in more detail below.

During the hold and spin feature game, all credit symbols, on or off the bingo line or located in another predefined pattern, may be held when the game operation is transitioned into the hold and spin feature game. In this embodiment, the credit symbols on bingo line 502 change color to indicate that the bingo line credit values will be awarded, which may be referred to as fast bingo. In this embodiment, three bonus spins are awarded regardless of the number of bingo lines or other predefined pattern matching of the credit symbols is achieved in the triggering game, illustrated in spin counter window 504. In other embodiments, a different number of bonus spins are awarded.

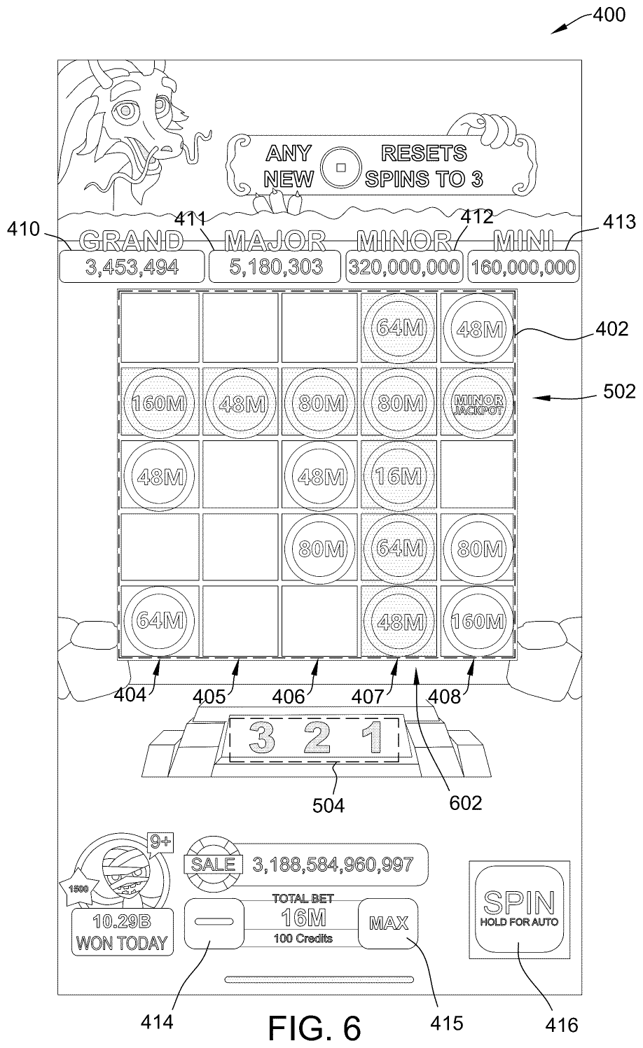

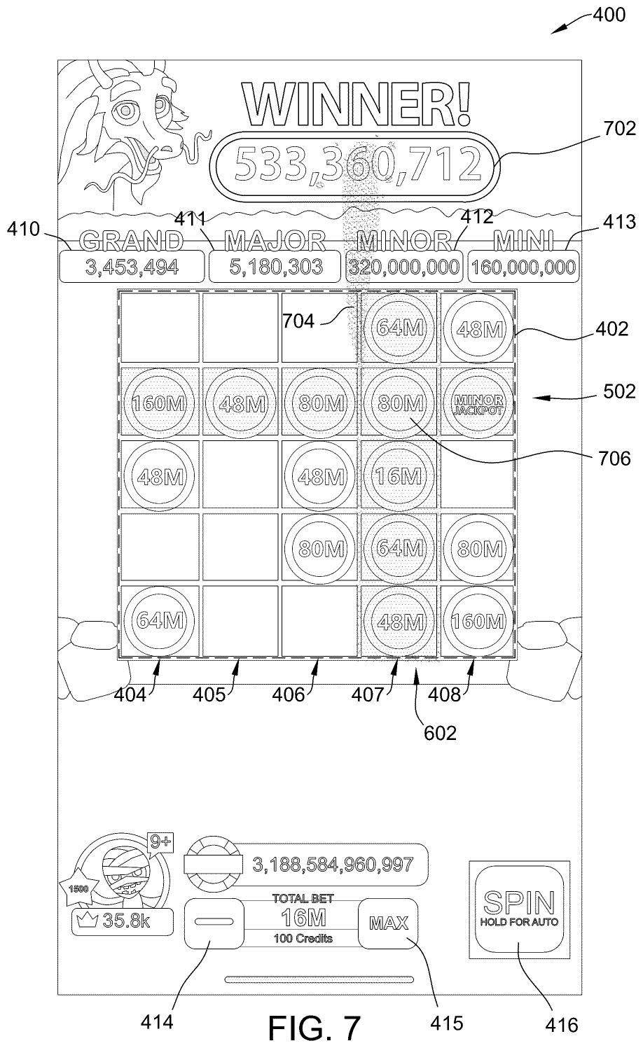

Each time a new credit symbol lands during the hold and spin feature game, the spin counter displayed in spin counter window 504 is reset. Any additional credit symbols that land on the matrix during the hold and spin feature game may stick to columns 404, 405, 406, 407, and 408 until the last spin is complete. Further, all reels in columns 404, 405, 406, 407, and 408 spin independently until all spins illustrated in spin counter window 504 are used. In an embodiment, any spin that forms one or more new bingo lines 602 or other predefined patterns (see FIG. 6) will award additional bonus spins (e.g., three additional spins). When the game operation lands a jackpot symbol during the hold and spin feature game, and the jackpot is on a winning bingo line or in the one or more predefined patterns, that jackpot is awarded at the end when the values are graphically added to a win meter 702 via a graphical feature 704 (see FIG. 7). When the game operation runs out of spins, all value symbol prizes on the wining bingo lines (e.g., bingo lines 502 and 602 in FIG. 7) or other predefined patterns are awarded (e.g., credits, jackpots, etc.). These values are also graphically added to win meter 702 via graphical feature 704. Further, positions with overlapping bingo lines or overlapping predefined winning patterns may be paid multiple times (e.g., position 706 in bingo lines 502 and 602 of FIG. 7). In some embodiments, additional visual features (not shown in FIG. 7) are utilized when paying out overlapping multiple bingo lines sharing a same bingo space. Value symbols that are not on a bingo line may not pay at the end of the play. In other embodiments, the bingo lines 502 and 602 may pay out a bonus (e.g., adding a multiplier to the values) while value symbols that land, but do not create a bingo line are either not paid out or are paid out without a bonus (e.g., not multiplier added to the values).

In some embodiments, if the game operation enters the hold and spin feature game without realizing a payout (e.g., the game operation enters the hold and spin feature game without obtaining a predefined pattern for payout in the base game, which is discussed in more detail below), and the game operation utilizes all spins without obtaining a predefined pattern for payout during the hold and spin feature game, then a random symbol may be inserted (e.g., a credit symbol) into the matrix and an additional number of spins may be awarded. In this case, the additional spins may be awarded until the game operation obtains the predefined pattern for payout, which ensures that the game operation provides wins of at least some credits during the game play session when the game operation enters the hold and spin feature game without first obtaining a pending payout.

When the game operation fills up the entire matrix (e.g., all twenty-five locations in play area 402) during the hold and spin feature game, they may be awarded the grand jackpot along with some or all the credit symbol values. In some embodiments, a pop up or another type of visual indicator is shown to the player before the values are graphically added to graphical feature 704 notifying the player that they have been awarded the grand jackpot on the matrix they filled. Following the end of the hold and spin feature game, the game operation returns to the base game play rules.

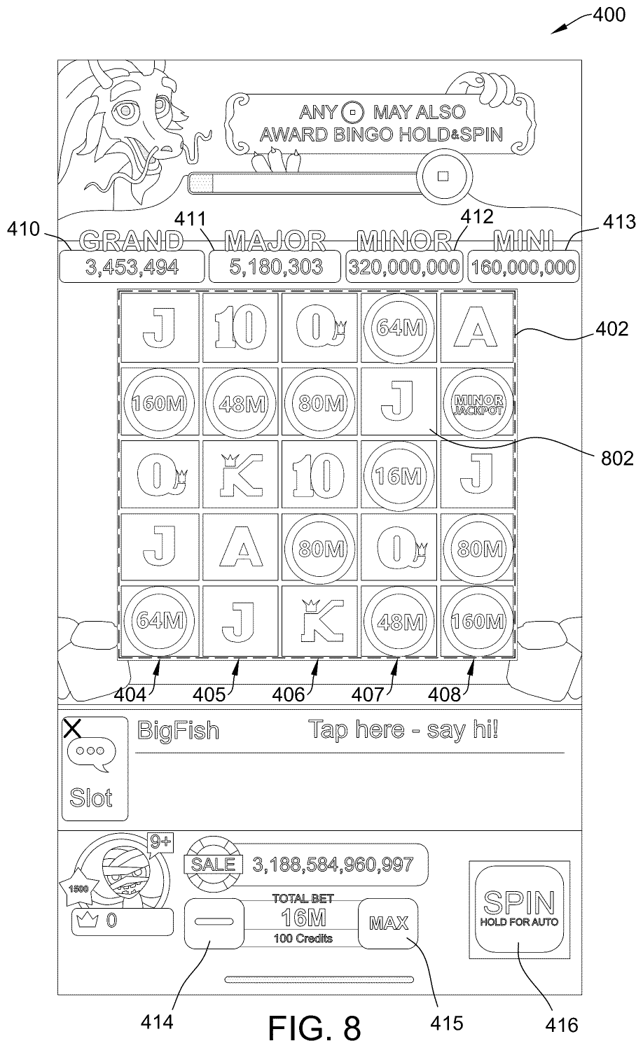

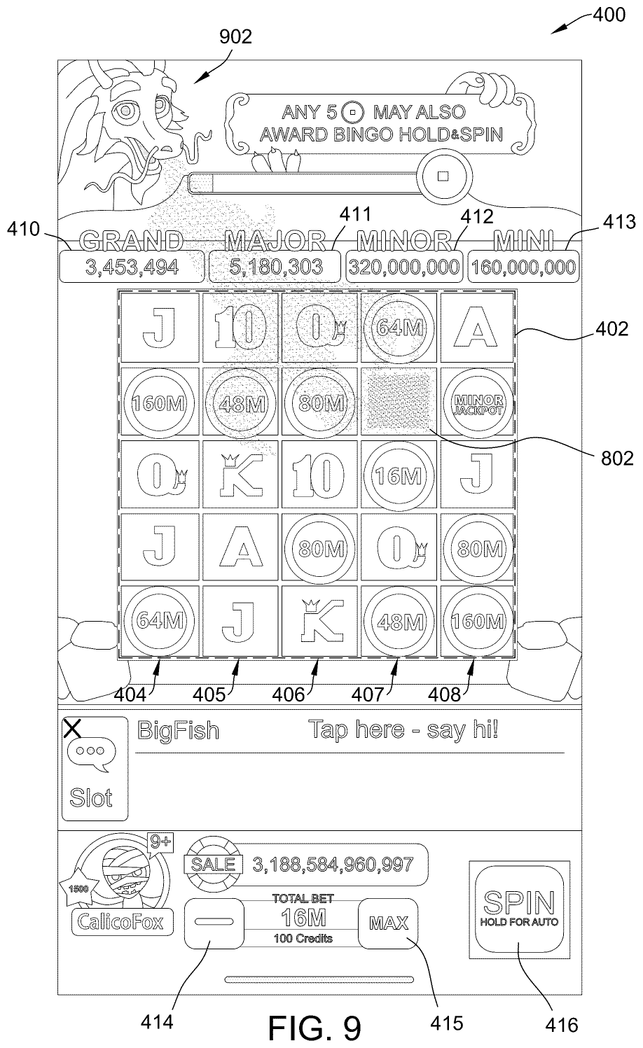

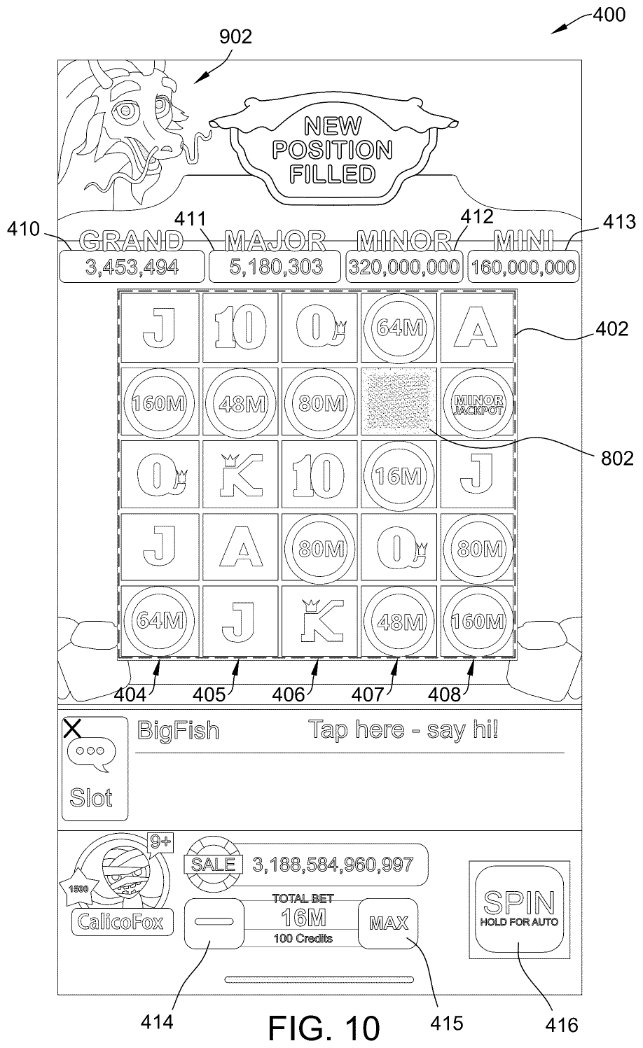

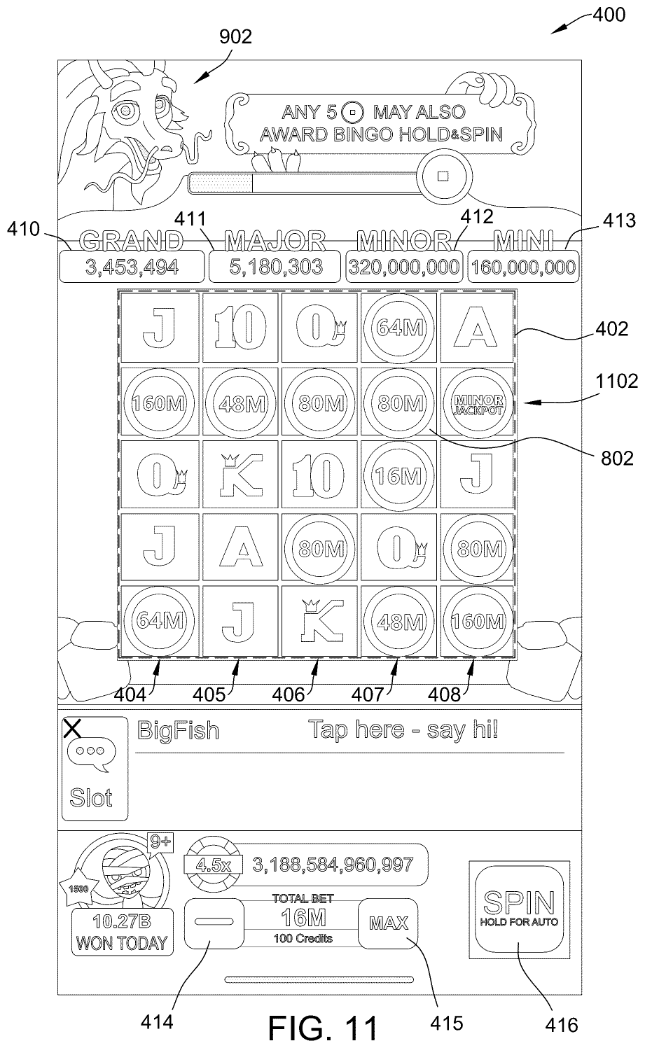

FIGS. 8-11 depicts examples of the gaming user interface 400 during a second chance feature. When the game operation has, for example, three to four bingo positions on a line filled, or some other number of filled positions on a predefined pattern, then there is a potential for a second chance to fill the unfilled positions. During the second chance feature, one, two, or another number of locations may be filled. For example, on a spin where some credit symbols have landed on reels in columns 404, 405, 406, 407, and 408, a bingo line or some other predefined pattern may be randomly completed by filling an unfilled location 802 (see FIG. 8). In this embodiment, location 802 is filled using an animated feature associated with a graphical character 902 (see FIG. 9), forming bingo line 1102 (see FIG. 11). During the second chance feature, when a bingo line or some other predefined pattern is achieved, then the game operation may transition into the hold and spin feature game.

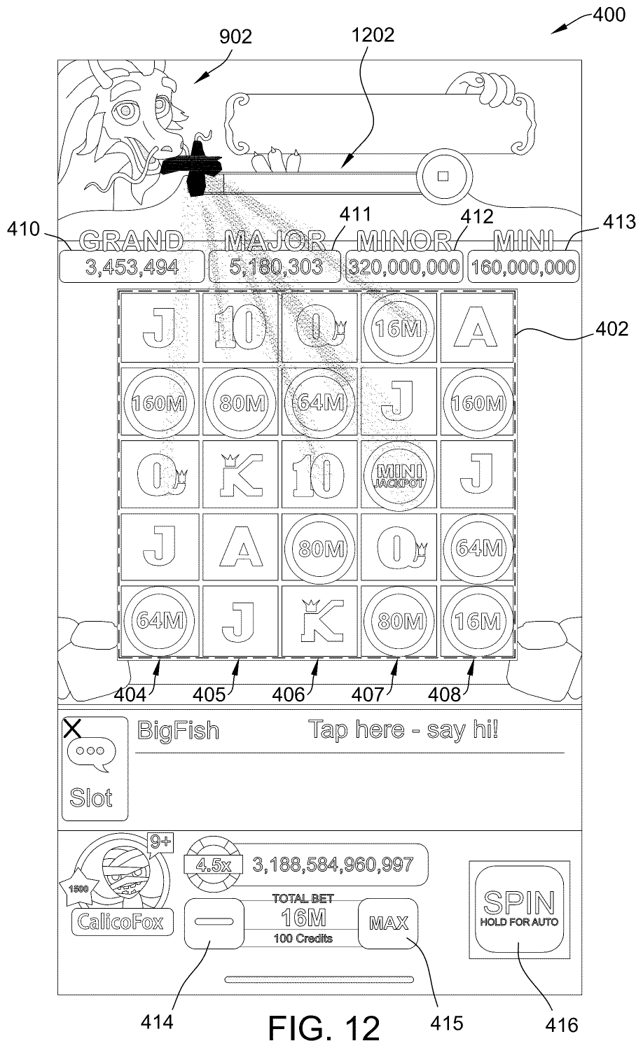

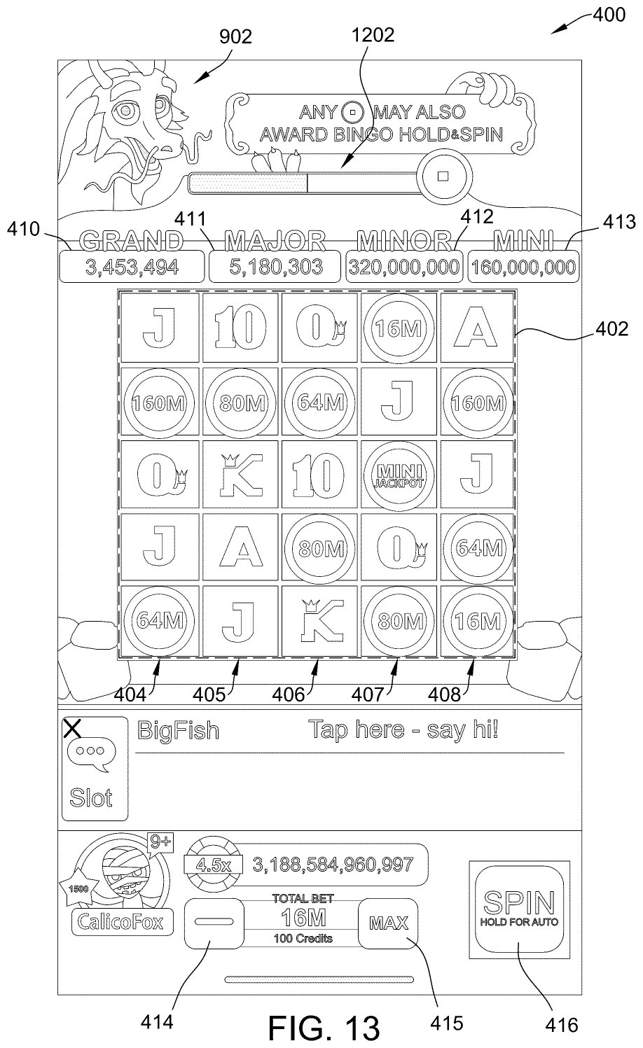

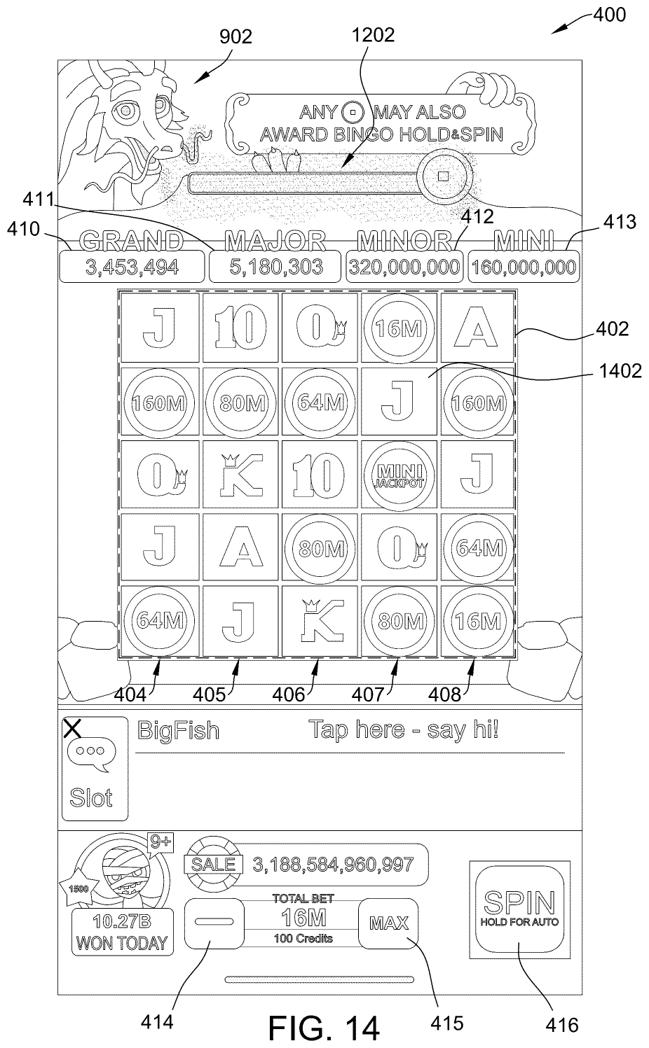

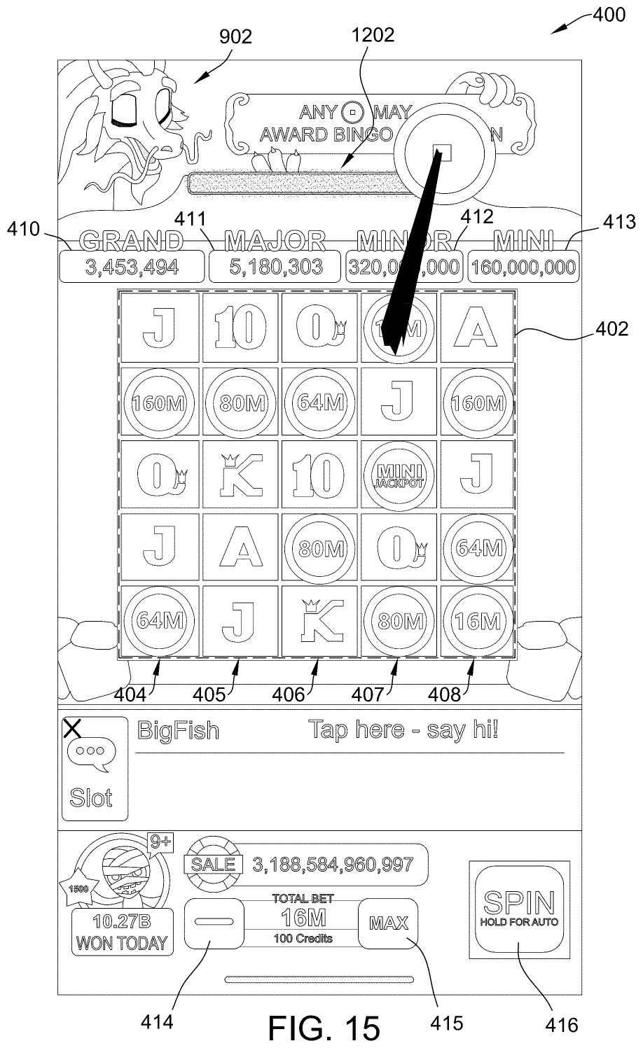

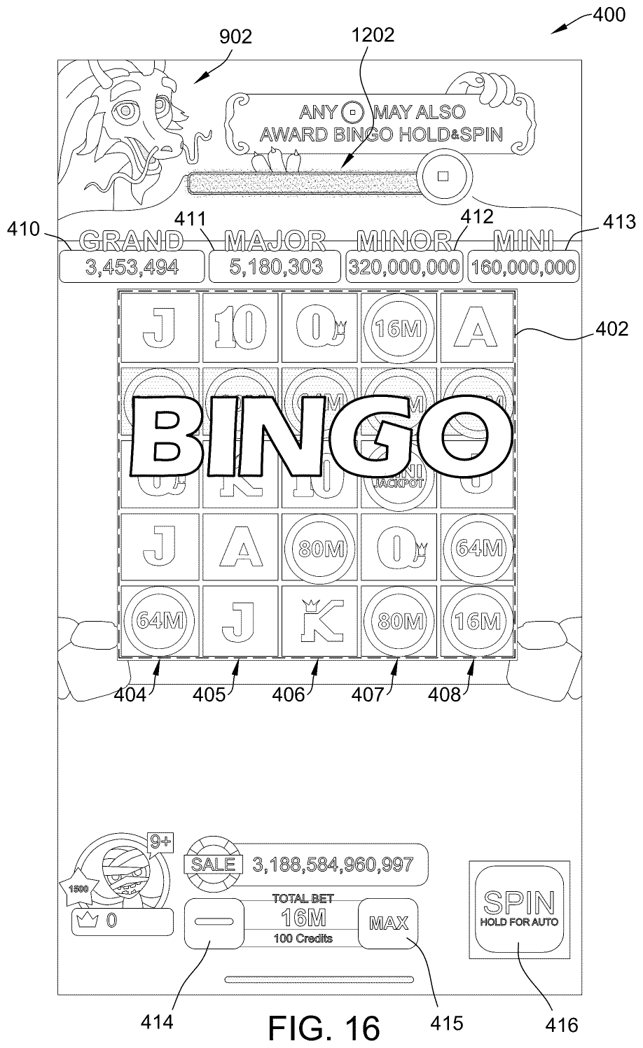

FIGS. 12-16 depict examples of gaming user interface 400 during the activation of a metamorphic feature. When a predefined trigger occurs (e.g., when a credit symbol lands in the matrix), an animation occurs (see FIG. 12) that graphically applies the credit symbols to a metamorphic bar 1202 above columns 404, 405, 406, 407, and 408. Metamorphic bar 1202 is a visual metamorphic, and the credit symbols applied may not be correlated to how metamorphic bar 1202 changes. A credit symbol landing on reels in columns 404, 405, 406, 407, and 408 and graphically applied to metamorphic bar 1202 may trigger an award, and the game operation provides a hold and spin feature game to the player. When metamorphic bar 1202 erupts (see FIG. 14), the game operation is transitioned into the hold and spin feature game, where an animation completes the bingo line (e.g., adds a value symbol to open position 1402 of FIG. 14) or some other predefined pattern before the hold and spin feature game begins (see FIGS. 15, 16). When a pre-determined number of credit symbols land on reels in columns 404, 405, 406, 407, and 408 in one spin (e.g., five), the credit symbols are graphically applied to metamorphic bar 1202 before the game operation transitions into the hold and spin feature game.

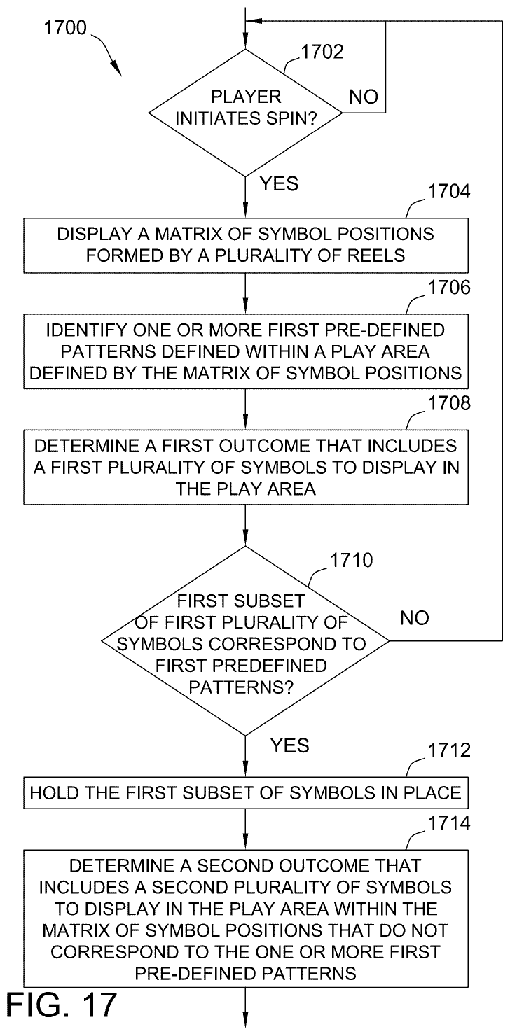

FIG. 17 is a flowchart illustrating and summarizing a gaming operation 1700 for implementing gaming user interface 400. In some embodiments, gaming operation 1700 may be executed by game controller 202 by executing instructions stored in memory 208. In other embodiments gaming operation 1700 may be executed by mobile gaming device 256. In other embodiments, one or more backend servers (e.g., server computers 102) may perform some or all of the functionality described herein for gaming operation 1700.

Accordingly, in the example embodiment, gaming user interface 400 may be displayed in response to a player placing a wager, such as, for example, using a “spin” button or one of the wager level buttons as described herein (block 1702). Further, in response to a player wager, reels in columns 404, 405, 406, 407, and 408 may be simulated to spin and stop based upon an output from RNG 212, whereby symbols may be displayed in a plurality of symbol positions of a matrix defined by reels in columns 404, 405, 406, 407, and 408 (block 1704). As discussed above, the reels defined by columns 404, 405, 406, 407, and 408 spin independently, and each reel may provide varying credit symbol distributions. The value of the symbols may be randomly selected from weighted tables, and the weighted tables may vary the distribution of the symbols based on their position within the matrix of the game play area 402 in some embodiments. In other words, each reel has a different density of credit symbols. By utilizing independent reels and varying the density of credit symbols for each the independent reels, the game operation provides a greater degree of control of when a bingo win line appears within a fewer number of spins (e.g., a single spin).

During game play, game controller 202 and/or mobile gaming device 256 and/or server computers 102 identify one or more first predefined patterns within play area 402 defined by the matrix (block 1706). The one or more first predefined patterns may correspond to bingo patterns previously described herein for play area 402, such as a bingo line.

Game controller 202 and/or mobile gaming device 256 and/or server computers 102 determine a first outcome that includes a first plurality of symbols to display in play area 402 (block 1708). Game controller 202 and/or mobile gaming device 256 and/or server computers 102 may then determine if a first subset of the symbols displayed in play area 402 correspond to the first predefined patterns (block 1710). For example, some of the symbols displayed in play area 402 correspond to bingo line 502 (see FIG. 5).

Game controller 202 and/or mobile gaming device 256 and/or server computers 102, in response to determining that the first subset of symbols correspond to the first predefined pattern, holds the first subset of symbols in place (1712) and determines a second outcome (1714) that includes a second plurality of symbols to display in play area 402 within the matrix of symbol positions that do not correspond to the one or more first predefined patterns. For example, the value symbols in bingo line 502 are held while reels in columns 404, 405, 406, 407, and 408 are re-spun during the hold and spin feature game previously described (see FIGS. 5-7). Game controller 202 and/or mobile gaming device 256 and/or server computers 102 may then determine a second subset of symbols of the second plurality of symbols displayed in play area 402 correspond to one or more second predefined patterns defined within the play area. For example, after the first hold and spin, additional symbols are displayed within play area 402 which may correspond to one or more second predefined patterns (e.g., one or more additional bingo patterns), which may be held in place during a subsequent spin. Thus, for each round of hold and spin, any number of pre-defined patterns may be used to determine which symbols to hold in place and which symbols to spin during the hold and spin feature game. For example, during a first round of hold and spin, a bingo line may be held in place, while in a subsequent round of hold and spin, a different pattern may be held in place, in addition to, or instead of, the bingo line, such as a four-corner pattern.

After each spin of reels in columns 404, 405, 406, 407, and 408, play area 402 may be evaluated to determine whether to provide game award (or awards). For example, as described above, the prize symbols displayed in play area 402 may be evaluated to determine whether one or more predefined winning patterns are formed by the prize symbols. If so, one or more awards may be provided. Likewise, if one or more jackpot symbols are included in the one or more predefined winning patterns (or in some embodiments, even if the jackpot symbols are not included in any winning pattern), one or more jackpots 410-413 may be provided. In the example embodiment, the prize symbols are total up including any jackpot awards along the bingo winning pattern and are awarded to the player as part of the bonus or feature game. Finally, a player may decide whether he or she wishes to either end or terminate gameplay by placing additional credit wagers and spinning reels in columns 404, 405, 406, 407, and 408. If, however, the player decides to continue gameplay by placing another credit wager, the player selects the credit wager level, and reels in columns 404, 405, 406, 407, and 408 are spun for the next game instance.

While the invention has been described with respect to the figures, it will be appreciated that many modifications and changes may be made by those skilled in the art without departing from the spirit of the invention. Any variation and derivation from the above description and figures are included in the scope of the present invention as defined by the claims.

What is claimed is:

1. An electronic gaming device comprising:
a display device;
at least one memory device; and
at least one processor configured to execute programmed instructions stored in the at least one memory device, which when executed, cause the at least one processor to:
control the display device to display a matrix of symbol positions included on a plurality of independent reels, wherein the matrix of symbol positions define a play area, and wherein the plurality of independent reels have different distributions of credit symbols;
identify one or more first predefined patterns defined within the play area;
in response to receipt of an input to play an instance of a game, determine a first outcome, based at least in part on an output of a random number generator (RNG), that includes a first plurality of symbols to display in the play area;
determine whether a first subset of symbols of the first plurality of symbols displayed in the play area correspond to the one or more first predefined patterns defined within the play area;
in response to determining that the first subset of symbols correspond to the one or more first predefined patterns defined within the play area, control the display device to hold at least the first subset of symbols in place within the play area; and
determine a second outcome, based at least in part on an output of the RNG, that includes a second plurality of symbols to display in the play area within the matrix of symbol positions that do not correspond to the one or more first predefined patterns.

2. The electronic gaming device of claim 1, wherein the programmed instructions further cause the at least one processor to:
determine whether a second subset of symbols of the second plurality of symbols displayed in the play area correspond to one or more second predefined patterns defined within the play area;
in response to determining that the second subset of symbols correspond to the one or more second predefined patterns defined within the play area, control the display device to hold at least the second subset of symbols in place within the play area; and
determine a third outcome, based at least in part on an output of the RNG, that includes a third plurality of symbols to display in the play area within the matrix of symbol positions that do not correspond to the one or more second predefined patterns.

3. The electronic gaming device of claim 1, wherein:
the first subset of symbols comprises the credit symbols.

4. The electronic gaming device of claim 1, wherein:
the one or more first predefined patterns comprise bingo patterns.

5. The electronic gaming device of claim 1, wherein the programmed instructions further cause the at least one processor to:
in response to determining that the first subset of symbols correspond to the one or more first predefined patterns defined within the play area, control the display device to hold at least one symbol of the first plurality of symbols in place that do not correspond with the one or more first predefined patterns.

6. The electronic gaming device of claim 1, wherein the programmed instructions further cause the at least one processor to:
evaluate the play area against a plurality of predefined winning bingo patterns to determine that a predefined winning bingo pattern is formed in the play area; and
in response to determining that the predefined winning bingo pattern is formed, determine an award value based at least in part on values of the credit symbols forming the predefined winning bingo pattern in the play area.

7. The electronic gaming device of claim 6, wherein:
the predefined winning bingo pattern comprises the one or more first predefined patterns.

8. A method operable by an electronic gaming device that includes a display device, the method comprising:
controlling the display device to display a matrix of symbol positions included on a plurality of independent reels, wherein the matrix of symbol positions define a play area, and wherein the plurality of independent reels have different distributions of credit symbols;
identifying one or more first predefined patterns defined within the play area;
in response to receipt of an input to play an instance of a game, determining a first outcome, based at least in part on an output of a random number generator (RNG), that includes a first plurality of symbols to display in the play area;
determining whether a first subset of symbols of the first plurality of symbols displayed in the play area correspond to the one or more first predefined patterns defined within the play area;
in response to determining that the first subset of symbols correspond to the one or more first predefined patterns defined within the play area, controlling the display device to hold at least the first subset of symbols in place within the play area; and
determine a second outcome, based at least in part on an output of the RNG, that includes a second plurality of symbols to display in the play area within the matrix of symbol positions that do not correspond to the one or more first predefined patterns.

9. The method claim 8, further comprising:
determining whether a second subset of symbols of the second plurality of symbols displayed in the play area correspond to one or more second predefined patterns defined within the play area;
in response to determining that the second subset of symbols correspond to the one or more second predefined patterns defined within the play area, controlling the display device to hold at least the second subset of symbols in place within the play area; and
determine a third outcome, based at least in part on an output of the RNG, that includes a third plurality of symbols to display in the play area within the matrix of symbol positions that do not correspond to the one or more second predefined patterns.

10. The method of claim 8, wherein:
the first subset of symbols comprises the credit symbols.

11. The method of claim 9, wherein:
the one or more first predefined patterns comprise bingo patterns.

12. The method of claim 9, further comprising:
in response to determining that the first subset of symbols correspond to the one or more first predefined patterns defined within the play area, controlling the display device to hold at least one symbol of the first plurality of symbols in place that do not correspond with the one or more first predefined patterns.

13. The method of claim 9, further comprising:
evaluating the play area against a plurality of predefined winning bingo patterns to determine that a predefined winning bingo pattern is formed in the play area; and
in response to determining that the predefined winning bingo pattern is formed, determining an award value based at least in part on values of the credit symbols forming the predefined winning bingo pattern in the play area.

14. The method of claim 13, wherein:
the predefined winning bingo pattern comprises the one or more first predefined patterns.

15. A non-transitory computer-readable medium embodying programmed instructions which, when executed by at least one processor of a gaming device that includes a display device, cause the at least one processor to:
control the display device to display a matrix of symbol positions included on a plurality of independent reels, wherein the matrix of symbol positions define a play area, and wherein the plurality of independent reels have different distributions of credit symbols;
identify one or more first predefined patterns defined within the play area;
in response to receipt of an input to play an instance of a game, determine a first outcome, based at least in part on an output of a random number generator (RNG), that includes a first plurality of symbols to display in the play area;
determine whether a first subset of symbols of the first plurality of symbols displayed in the play area correspond to the one or more first predefined patterns defined within the play area;
in response to determining that the first subset of symbols correspond to the one or more first predefined patterns defined within the play area, control the display device to hold at least the first subset of symbols in place within the play area; and
determine a second outcome, based at least in part on an output of the RNG, that includes a second plurality of symbols to display in the play area within the matrix of symbol positions that do not correspond to the one or more first predefined patterns.

16. The non-transitory computer-readable medium of claim 15, wherein the programmed instructions further cause the at least one processor to:
determine whether a second subset of symbols of the second plurality of symbols displayed in the play area correspond to one or more second predefined patterns defined within the play area;
in response to determining that the second subset of symbols correspond to the one or more second predefined patterns defined within the play area, control the display device to hold at least the second subset of symbols in place within the play area; and
determine a third outcome, based at least in part on an output of the RNG, that includes a third plurality of symbols to display in the play area within the matrix of symbol positions that do not correspond to the one or more second predefined patterns.

17. The non-transitory computer-readable medium of claim 15, wherein:
the first subset of symbols comprises the credit symbols.

18. The non-transitory computer-readable medium of claim 15, wherein:
the one or more first predefined patterns comprise bingo patterns.

19. The non-transitory computer-readable medium of claim 15, wherein the programmed instructions further cause the at least one processor to:
in response to determining that the first subset of symbols correspond to the one or more first predefined patterns defined within the play area, control the display device to hold at least one symbol of the first plurality of symbols in place that do not correspond with the one or more first predefined patterns.

20. The non-transitory computer-readable medium of claim 15, wherein the programmed instructions further cause the at least one processor to:
evaluate the play area against a plurality of predefined winning bingo patterns to determine that a predefined winning bingo pattern is formed in the play area, wherein the predefined winning bingo pattern comprises the one or more first predefined patterns; and
in response to determining that the predefined winning bingo pattern is formed, determine an award value based at least in part on values of the credit symbols forming the predefined winning bingo pattern in the play area.
